(19) United States
(12) Patent Application Publication
(10) Pub. No.: US 2026/0301085 A1
(43) Pub. Date: Oct. 1, 2026

(54) POWER MANAGEMENT SYSTEM, POWER MANAGEMENT METHOD, AND INFORMATION PROCESSING APPARATUS

(71) Applicant: HONDA MOTOR CO., LTD., Tokyo (JP)

(72) Inventors: Toru KIMURA, Wako-shi (JP); Martin KOPP, Offenbach/Am Main (DE); Christian KOEBEL, Offenbach/Am Main (DE)

(73) Assignee: HONDA MOTOR CO., LTD., Tokyo (JP)

(21) Appl. No.: 19/549,302

(22) Filed: Feb. 25, 2026

(30) Foreign Application Priority Data
Mar. 28, 2025 (JP) 2025-056804

(51) Int. Cl. G06Q 50/06; H04L 9/00

(52) U.S. Cl. CPC G06Q 50/06; H04L 9/50

(57) ABSTRACT

A power management system is configured to manage a transaction of power derived from renewable energy. The power management system holds first identification information, which is given to a battery, and which is identification information in a first blockchain, and second identification information, which is identification information in a second blockchain, stores, in the first blockchain, a transaction result of the power derived from the renewable energy, which is obtained from a charging station and charged in the battery, in association with the first identification information, stores, in the second blockchain, a transaction history of a token in accordance with the transaction result in association with the second identification information; and stores association information in which the first blockchain and the second blockchain are associated with each other.

### CROSS-REFERENCE TO RELATED APPLICATION(S)

This application claims priority to and the benefit of Japanese Patent Application No. 2025-056804 filed on Mar. 28, 2025, the entire disclosure of which is incorporated herein by reference.

### BACKGROUND OF THE INVENTION

### Field of the Invention

The present invention relates to transaction of electric power derived from renewable energy such as solar power, wind power, and hydraulic power.

### Description of the Related Art

In recent years, research and development on renewable energy that contributes to energy efficiency has been conducted to enable more people to have access to affordable, reliable, sustainable, and advanced energy. The renewable energy includes various types of energy such as solar power, wind power, hydraulic power, biomass, geothermal heat, snow and ice heat, temperature difference heat, and tidal stream, and the energy is often used for power generation. The electric power derived from renewable energy is high in environmental value, and a technique has been proposed for giving an asset for its evaluation, and storing a history of charge and discharge of the electric power derived from the renewable energy and movement of the asset between users in a blockchain (see Japanese Patent Laid-Open No. 2022-31869).

In the technique related to the renewable energy, particularly, in the management of the electric power derived from the renewable energy, a problem arises in verifying that a transaction object is the electric power derived from the renewable energy in the process of transaction or the like.

In the above related art, however, in order to verify the history of charging and discharging the electric power derived from the renewable energy, it is necessary to confirm that the charged amount and discharged amount are measured by an authorized meter, and that the authorization is also correctly conducted, with regard to all meters involved in the charge and discharge that are to be verified and that have been recorded in the blockchain.

### SUMMARY OF THE INVENTION

The present invention ensures transparency of transaction records of electric power derived from renewable energy, and enables verification by a third party.

Hence, the following configuration is proposed. According to one aspect of the present invention, there is provided a power management system configured to manage a transaction of power derived from renewable energy, the power management system comprising: a storage configured to hold first identification information, which is given to a battery, and which is identification information in a first blockchain, and second identification information, which is identification information in a second blockchain, at least one memory storing instructions; and at least one processor that is in communication with the at least one memory and that, when executing the instructions, cooperates with the at least one memory to execute processing, the processing including: storing, in the first blockchain, a transaction result of the power derived from the renewable energy, which is obtained from a charging station and charged in the battery, in association with the first identification information; storing, in the second blockchain, a transaction history of a token in accordance with the transaction result in association with the second identification information; and storing association information in which the first blockchain and the second blockchain are associated with each other.

According to another aspect of the present invention, there is provided an information processing apparatus configured to manage a transaction of power derived from renewable energy, the information processing apparatus comprising: a storage configured to hold first identification information, which is given to a battery, and which is identification information in a first blockchain, and second identification information, which is given to a battery, and which is identification information in a second blockchain, at least one memory storing instructions; and at least one processor that is in communication with the at least one memory and that, when executing the instructions, cooperates with the at least one memory to execute processing, the processing including: acquiring a transaction result of the power derived from the renewable energy; storing, in the first blockchain, the transaction result in association with the first identification information; and storing, in the second blockchain, a transaction history of a token in accordance with the transaction result of the power in association with the second identification information, wherein the first blockchain and the second blockchain are associated with each other by association information, in which the first identification information and the second identification information are associated with each other, and which is held in a third holding unit.

According to the above configuration, transparency of transaction records of electric power derived from renewable energy is ensured, and verification by a third party is enabled.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a power management system according to an embodiment;

FIG. 2 is a block diagram of an information processing apparatus that constitutes an entity according to an embodiment;

FIG. 3 is a block diagram illustrating a software configuration of the power management system according to an embodiment;

FIG. 4 is a flowchart of processing at the time of charging by an entity according to an embodiment;

FIG. 5A is a flowchart of processing of power consumption by an entity according to an embodiment;

FIG. 5B is a flowchart of processing of token transaction by an entity according to an embodiment; and

FIG. 6 is a flowchart of verification processing of power transaction by an entity according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

### Configuration of Power Management System

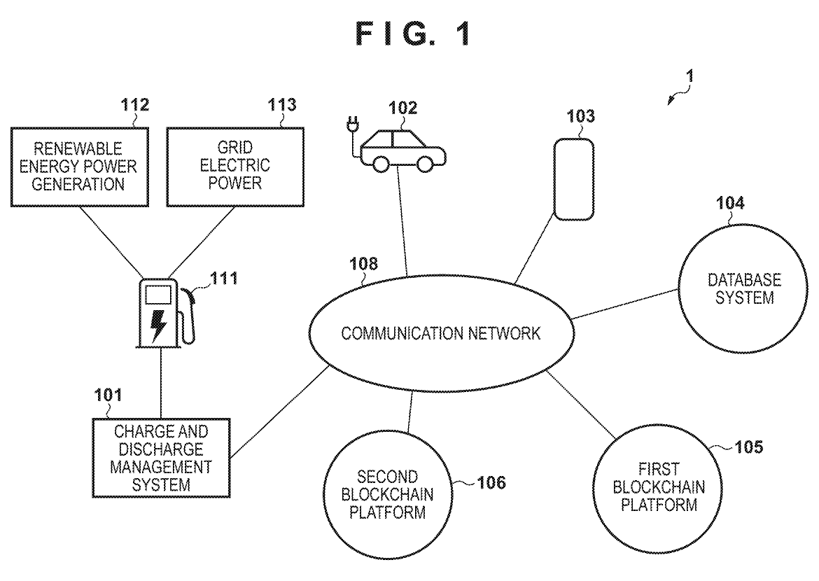

FIG. 1 illustrates an example of a configuration of a power management system 1 according to the present embodiment. The power management system 1 includes a charging station 111, an electric vehicle 102, a mobile terminal 103, a database system 104, a first blockchain platform 105, a second blockchain platform 106, and the like. These components will be referred to as entities, in some cases.

The charging station 111 is capable of receiving electric power from renewable energy power generation 112, and charging an apparatus including a rechargeable battery, such as the electric vehicle 102, the mobile terminal 103, and a portable battery unit. Examples of the renewable energy for use in power generation include solar power, wind power, biomass, hydraulic power, geothermal heat, solar heat, snow and ice heat, wave power, and temperature difference heat. The charging station 111 includes a watt meter that measures the amount of power that has been generated by the renewable energy and charged from the charging station 111 to another apparatus. Such an amount of power is the amount of discharged power, when viewed from the charging station 111, and thus it will also be referred to as a discharged amount. Alternatively, when viewed from the charged side, it will be referred to as a charged amount, in some cases. Note that the electric power generated by the renewable energy will be referred to as renewable energy-derived power, but the electric power to be described in the present embodiment is the renewable energy-derived power, and thus it will also be simply referred to as the power. In addition, the charging station 111 can receive not only the supply from the renewable energy power generation 112 but also supply of system power from an electric power company or the like, but in the present embodiment, description will be made focusing on the renewable energy-derived power.

The charging station 111 transmits a discharged amount of the renewable energy-derived power that has been measured by the watt meter to an information processing apparatus (a computer) in which a charge and discharge management system 101 is installed. The information processing apparatus in which the charge and discharge management system 101 is installed is connected with a communication network 108. The charge and discharge management system 101 stores (or records), in a first blockchain, information of the discharged amount of the renewable energy-derived power, as a power transaction result, together with other information. The charge and discharge management system 101 also stores, in a second blockchain, a transaction history including generation and extinction of a token generated in accordance with a transaction of the renewable energy-derived power. The charge and discharge management system 101 is also installed in the electric vehicle 102, the mobile terminal 103, and the like (omitted in FIG. 1), and is capable of storing a transaction result of the renewable energy-derived power, a transaction history of the token, and the like.

The electric vehicle 102 is a vehicle to be driven with a battery, which is chargeable from the outside, as a power source, and will also be referred to as an EV. The electric vehicle 102 includes not only a so-called battery EV but also a plug-in hybrid EV. The electric vehicle 102 is capable of charging its battery with the power supplied from the charging station 111, and the charged power can be not only consumed by the electric vehicle 102 but also supplied to another apparatus. As described above, the watt meter and the charge and discharge management system 101 are also provided in the electric vehicle 102, and it is possible to store a transaction result of the renewable energy-derived power and a transaction history of the token generated in accordance with the transaction of the renewable energy-derived power in each blockchain. In addition, using the user interface of an in-vehicle computer of the electric vehicle 102 in which the charge and discharge management system is installed, a transaction of only a token without the transaction of the power is also enabled, and the transaction history can be stored in the blockchain.

The mobile terminal 103 is, for example, a smartphone, a tablet terminal, a personal computer, or the like. The mobile terminal 103 is used for referring to the transaction of the token and the transaction result of the power, referring to the transaction history of the token, and the like. Since the mobile terminal 103 includes the watt meter, it is possible to fulfill a function similar to that of the above-described charge and discharge management system 101 of the electric vehicle 102. However, the capacity of the battery is much smaller than that of the electric vehicle 102, and thus a history of the transactions of the power of the mobile terminal 103 itself may not necessarily be stored.

The database system 104 is, for example, a database implemented on one or a plurality of computers, and according to the present embodiment, a verifiable data registry is stored.

The first blockchain platform 105 is a platform on which a first blockchain is implemented, and a transaction result of the power is stored in the first blockchain. The first blockchain platform 105 may be an existing commercial blockchain platform. Note that the blockchain is distributed to and implemented on a plurality of computers, and the first blockchain platform 105 includes a plurality of computers and the network. This network is a different one from the communication network 108 for convenience of description, but may include a part or the entirety of the communication network 108. As the first blockchain platform 105, for example, an integrated trust network (ITN) or the like corresponding to a decentralized identifier (DID) to be described later can be used. The DID is not intensively managed by a specific administrator, and is a system in which an ID holder defines a method corresponding to the ID to enable processing in accordance with the defined method.

The second blockchain platform 106 is a platform on which, for example, a second blockchain or the like is implemented, and a transaction history of the token generated in accordance with the renewable energy-derived power supplied to the power management system 1 is stored in the second blockchain. The second blockchain platform 106 may also be an existing commercial blockchain platform. As the second blockchain platform 106, for example, Ethereum (registered trademark) suitable for managing tokens can be used. Note that the blockchain is distributed to and implemented on a plurality of computers, and the second blockchain platform 106 includes a plurality of computers and the network. This network is a different one from the communication network 108 for convenience of description, but may include a part or the entirety of the communication network 108.

The above-described components are connected with one another through the communication network 108, and the charge and discharge management system 101 of each apparatus is capable of accessing the database system 104, the first blockchain platform, and the second blockchain platform. However, with regard to this access, authentication of an access requester may be conditional.

### Hardware Configuration of Computer

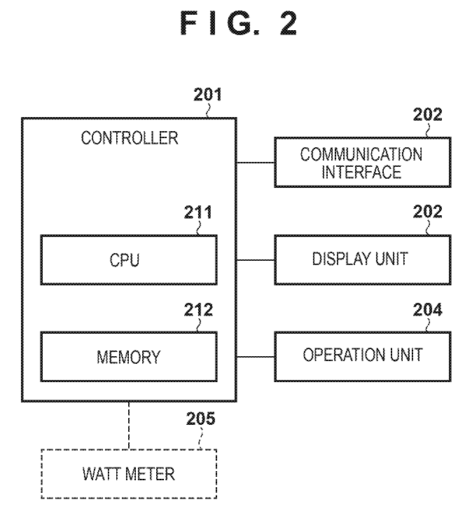

FIG. 2 is a block diagram illustrating an example of hardware of a computer in which the charge and discharge management system 101 is installed. A controller 201 includes a CPU 211 and a memory 212. The CPU 211 achieves the charge and discharge management system 101, by executing a program loaded onto the memory 212. A communication interface 202 is a wired or wireless communication interface for connection to the communication network 108. A display unit 203 displays a message, an image, and the like, and an operation unit 204 receives an operation input from a user. The display unit 203 and the operation unit 204 achieve a user interface. A watt meter 205 is a meter that measures the power to be measured, and is included in, for example, the charging station 111 and the charge and discharge management system of the electric vehicle 102. The watt meter 205 may be provided in the mobile terminal 103 in a case where the transaction of the power stored in the battery is to be managed. However, the watt meter 205 may not necessarily be provided in a case where the transaction is not to be managed.

### Software Configuration of Power Management System

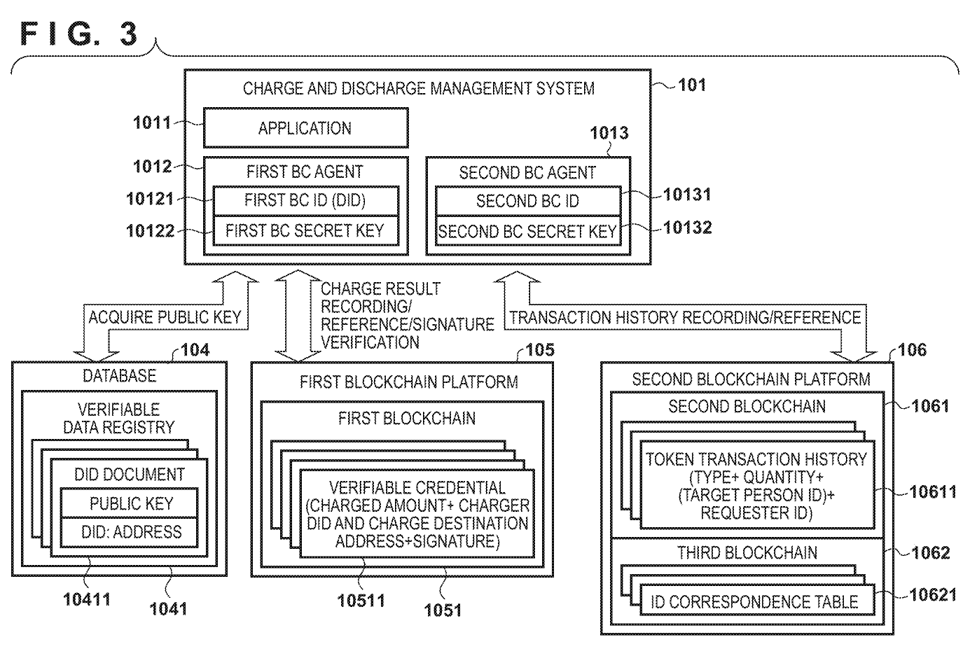

FIG. 3 illustrates configurations of the charge and discharge management system 101 and the database system 104 to be installed in the computer illustrated in FIG. 2. FIG. 3 also illustrates a data configuration of a first blockchain 1051, which is configured on the first blockchain platform 105, and data configurations of a second blockchain 1061 and a third blockchain 1062, which are configured on the second blockchain platform 106. Note that the blockchain itself has a configuration in which blocks are linked together in a chain, and has a redundant configuration in a plurality of sites, and each block is configured to include a transaction and its hash value, and a hash value of an adjacent block connected in the chain. An example of a transaction stored in a block is illustrated in each blockchain of FIG. 3.

### Charge and Discharge Management System

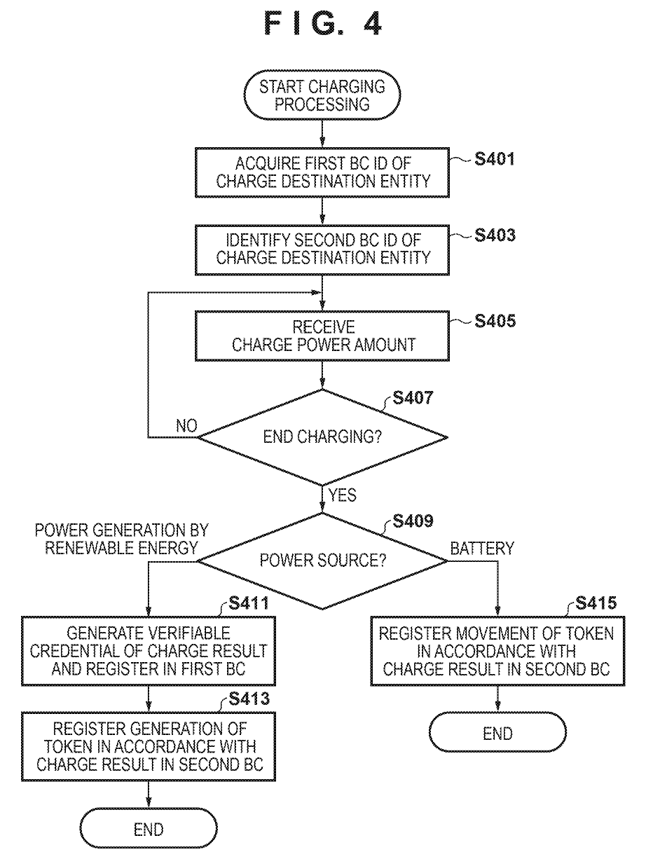

The charge and discharge management system 101 includes: an application 1011; an agent (a first BC agent) 1012 of the first blockchain; and an agent (a second BC agent) 1013 of the second blockchain. Here, in the drawing, BC denotes an abbreviation of a blockchain. The application 1011 is a program that performs a procedure illustrated in FIGS. 4 to 6 to be described later.

The first BC agent 1012 is a software module used for recording data in the first blockchain, which is configured on the first blockchain platform 105, and referring to the data. The first BC agent may be software supplied by an operator of the first blockchain platform 105. A first blockchain ID (the ID of the first BC) 10121 denotes identification information given to each charge and discharge management system 101 in the first blockchain. The charge and discharge management system 101 is provided in each the charging station 111, the electric vehicle 102, the mobile terminal 103, and the like. Therefore, it can be said that the ID 10121 of the first BC is identification information given to each apparatus (each entity). Alternatively, since each apparatus includes a battery (a storage battery), it can be said that the identification information is given to the storage battery. In the present embodiment, the distributed identifier (decentralized identifier: DID) is used as the ID of the first BC. Therefore, in the present embodiment, the ID of the first blockchain will be referred to as the DID, in some cases. A first blockchain secret key 10122 denotes a secret key for use in creating an electronic signature.

Here, the DID is a technology, the standardization of which is in progress, and which enables identification information (ID) without use of a certification body or the like. In the present embodiment, identification information based on the DID technology will also be referred to as the DID. In the DID technology, an ID (DID) may include a character string such as a URI, for example, and is resolved by a DID document 10411, which corresponds to the DID, and which is stored in a verifiable data registry 1041 to be described below. In the present embodiment, it is possible to verify a verifiable credential stored in the first blockchain using the DID document.

The second BC agent 1013 denotes a software module used for recording data in the first blockchain and the third blockchain, which are configured on the second blockchain platform 106, and also used for referring to the data. The second BC agent may be software supplied by an operator of the second blockchain platform 106. A second blockchain ID (the ID of the second BC) 10131 denotes identification information given to each charge and discharge management system 101 in the second blockchain. The charge and discharge management system 101 is provided in each the charging station 111, the electric vehicle 102, the mobile terminal 103, and the like. Therefore, it can be said that the ID 10131 of the second BC denotes identification information given to each apparatus (each entity). Alternatively, since each apparatus includes a battery (a storage battery), it can be said that the identification information is given to the storage battery. A second blockchain secret key (a second BC secret key) 10132 denotes, for example, a secret key for use in the electronic signature, and it is possible to include the electronic signature created with the secret key in a transaction stored in the second blockchain.

In the present embodiment, for example, Ethereum (registered trademark) can be used as the second blockchain. In this case, an Ethereum wallet can be used as the second BC agent 1013, and an Ethereum ID can be used as the second blockchain ID 10131. Note that the second BC agent 1013, ID 10131 of the second BC, and the second BC secret key 10132 can also be used for the third blockchain, which is constructed on the second blockchain platform 106.

Note that in FIG. 3, agents of the respective blockchains have the blockchain IDs and the secret keys, but they may be stored outside the agents.

### Verifiable Data Registry

The verifiable data registry 1041 is constructed in the database system 104. The verifiable data registry 1041 includes data called a DID document as a record associated with the DID, and it is possible to identify the DID document using the DID as a key. Each DID document 10411 includes a public key corresponding to a DID, the DID, and a MAC address of an entity to which the DID is given. The public key denotes a public key corresponding to a first BC secret key, and can be used for verifying the electronic signature using the first BC secret key. The MAC address is a unique address given to a communication interface.

### First Blockchain and Verifiable Credential

The first blockchain 1051 is constructed on the first blockchain platform 105. The first blockchain 1051 is a blockchain that includes a verifiable credential 1052 as a transaction.

The verifiable credential 1052 denotes information in which information about a transaction result of the power is recorded in a verifiable manner, in charging the renewable energy-derived power from the charging station 111 to the electric vehicle 102 or the like. The verifiable credential 1052 includes

Charged amount,

DID of a charge source entity,

MAC address of a charge destination entity, and

Electronic signature by the charge source.

Here, the charge source denotes a supply source that has supplied the renewable energy-derived power, and is, for example, the charging station 111. On the other hand, the charge destination denotes a supply destination that has received the renewable energy-derived power, and is, for example, the electric vehicle 102. In the present embodiment, what is recorded as the power transaction result is the power that has been supplied from the renewable energy power generation 112 and charged, so the entity of the charge source is the charging station 111, and the entity of the charge destination is the electric vehicle 102 or the like. The electronic signature may be, for example, a value obtained by encrypting a hash value of document data including the charged amount, the DID of the entity of the charge source, and the MAC address of the entity of the charge destination with the first BC secret key of the charge source. Therefore, the verifiable credential is verifiable with the public key corresponding to the first BC secret key. Information obtained by excluding the electronic certificate from the information included in the verifiable credential will be collectively referred to as a charge result, in some cases.

### Second Blockchain and Token Transaction History

The second blockchain 1061 is constructed on the second blockchain platform 106. The second blockchain 1061 denotes a blockchain including a token transaction history 10611 as a transaction.

The token transaction history 10611 includes a transaction history of a green token (also simply referred to as the token), which is issued when the charging station 111 charges the renewable energy-derived power for the electric vehicle 102 or the like. The transaction history of the token includes

Transaction type (addition, deletion, movement),

Quantity of tokens,

ID of a movement object, and

ID of an operation requester.

Here, each ID is an ID of the first blockchain. The “addition” in the transaction type corresponds to the issue of the token in accordance with the amount of power of the renewable energy-derived power that has been newly supplied from the renewable energy power generation 112 or the like to the power management system 1, and that has been used for charging. In this case, the ID of the movement object may be the ID of an apparatus that has been charged, and the operation requester may be the ID of the charging station that has charged using the renewable energy-derived power. That is, with regard to the transaction having “addition” in the transaction type, the ID of the movement object (the ID of the second BC) is the ID of the second BC corresponding to the ID of the entity of the charge destination (the ID of the first BC) included in the above-described charge result. In addition, the ID of the operation requester (the ID of the second BC) is the ID of the second BC corresponding to the ID of the entity of the charge source (the ID of the first BC) included in the above-described charge result.

The “deletion” corresponds to deletion of the token in accordance with the amount of consumed power as the renewable energy-derived power is consumed. In this case, there is no movement object, and the operation requester may be an apparatus that has consumed the power.

The “movement” corresponds to a transfer of the token to a supply destination in accordance with the amount of supplied power, in supplying another apparatus with the renewable energy-derived power that has been once supplied to the power management system 1 and then charged in the battery. The ID of the operation requestor may be the ID of an apparatus that has become a power source for charging, and the ID of the movement object may be the ID of an apparatus that has been charged.

### Third blockchain and ID Correspondence Table

The third blockchain 1062 is also constructed on the second blockchain platform 106. The third blockchain 1062 is a blockchain including an ID correspondence table 10621 as a transaction.

The ID correspondence table 10621 denotes a table in which a first blockchain ID and a second blockchain ID, each of which is given to a specific entity, are associated with each other to correspond to each other. Here, the ID correspondence table 10621 itself is stored in the blockchain, but an operation history (addition, deletion, or change) of the ID correspondence table 10621 may be stored. With such an ID correspondence table, it is possible to identify, for example, the first blockchain ID of a certain entity from the second blockchain ID of such an entity.

### Charging Processing

Now, description will be made with regard to an example of a processing procedure performed by the application 1011 in the power management system 1, which includes the above hardware and software. The application 1011 is loaded onto the memory 212, and is executed on the CPU 211, so the CPU 211 serves as the subject of performing the processing to be described below. First, processing at the time of charging will be described with reference to FIG. 4.

In step S401, the CPU 211 acquires the ID of the first BC assigned to a charge target entity. In charging, a charging cable connects the charging side and a charge target, and, for example, a communication cable is provided together with the charging cable, and is communicated in accordance with its connection. The ID of the first BC may be directly acquired from the charge target entity through the communication cable. Alternatively, the ID of the first BC may be acquired from the charge target entity through the communication network 108.

In step S403, the CPU 211 acquires the ID of the second BC, which is assigned to the charge target entity. The ID of the second BC may be received in the same manner as the ID of the first BC, but the ID of the second BC may be identified from the ID of the first BC. In such a case, it is sufficient to acquire the ID of the second BC associated with the ID of the first BC, which is assigned to the charge target entity, by referring to the third blockchain 1062.

In step S405, the CPU 211 receives the charge amount for the entity to be charged, for example, the electric vehicle 102. For example, the control in charging is achieved by the charging station 111 or a module for controlling the charge for the electric vehicle 102, and thus it is sufficient for the charge and discharge management system 101 to receive the charged amount (here, the charged amount of the renewable energy-derived power) as its result. Note that in the present example, the charged amount is received periodically and at the end of charging, and the values are added up. However, the total charged amount may be received at the end of charging.

In step S407, the CPU 211 determines whether charging has been completed. The completion of charging may be determined, based on a notification from the charging station 111 or the module for controlling the charge for a vehicle or the like. Alternatively, when the total charged amount is received at one time, it may be determined that charging has ended in accordance with its reception.

In step S409, the CPU 211 determines what the power source for charging is. In a case where the power source is power generation using renewable energy, the processing branches to S411. In a case where the power source is a battery, the processing branches to S415. This determination can be replaced with, for example, a determination of whether the entity performing the processing of FIG. 4 is a charging station. In this case, in a case of the charging station, the processing branches to S411. In the other case, for example, in a case of an electric vehicle, the processing branches to S415. That is, in a case where the charged power is the renewable energy-derived power to be newly managed by the power management system 1, the processing proceeds to S411. In a case where it is the renewable energy-derived power that has been already managed, the processing proceeds to S415.

In step S411, the CPU 211 generates the verifiable credential 1052, based on a charge result, and registers (stores) the generated verifiable credential in the first blockchain 1051. As described above, the verifiable credential 1052 includes the electronic signature and the charge result such as the charged amount, the DID of the charge source entity, and the MAC address of the charge target entity.

In step S413, the CPU 211 generates a token transaction history in accordance with the charge result, and registers the token transaction history in the second blockchain 1061. In S413, the transaction type of the transaction history is “addition”, and the token quantity is a value that has been set beforehand in accordance with the amount of charged power. In addition, the ID of the movement object is the ID of the second blockchain 1061 given to the charge target entity, in a case of, for example, the electric vehicle 102. Further, the ID of the operation requester is the ID of the second blockchain 1061 given to the charging station 111, in a case where charging has been conducted in the charging station 111.

In step S415, the CPU 211 generates a token transaction history in accordance with the charge result, and registers the token transaction history in the second blockchain 1061. In S415, the transaction type of the transaction history is “movement”, and the token quantity is a value that has been set beforehand in accordance with the amount of charged power. In addition, the ID of the movement object is the ID of the second blockchain 1061 given to the charge target entity, in a case of, for example, an electric vehicle other than the electric vehicle 102. Further, the ID of the operation requester is the ID of the second blockchain 1061 given to the electric vehicle 102, in a case where charging has been conducted from the electric vehicle 102.

According to the above procedure, at the time of charging, in the case where charging is conducted using the renewable energy-derived power newly managed by the power management system 1, the verifiable credential corresponding to the charged amount is registered in the first blockchain 1051. In addition, the generation of the green token corresponding to the amount of charged power or a movement history is registered in the second blockchain 1061.

Note that the registration of the transaction history of the token in the second blockchain in steps S413 and S415 may be enabled by using, for example, a mechanism supplied by the second blockchain platform 106, for example, a mechanism called a smart contract or the like, without being performed on the application 1011.

### Power Consumption Processing

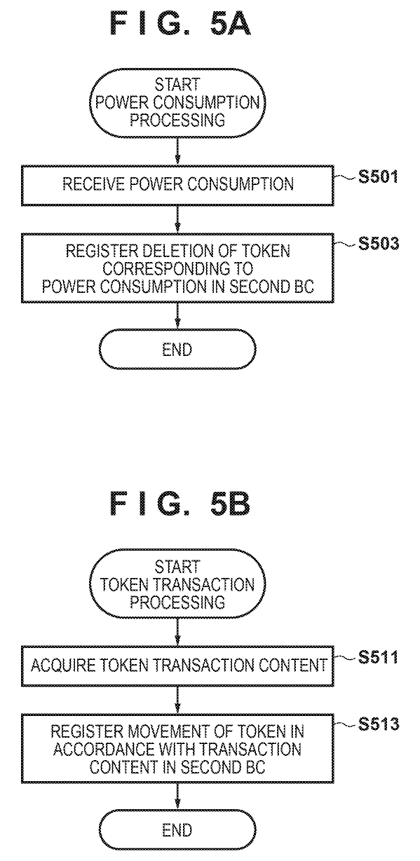

The power that has been charged in the battery is consumed by a load of the entity. The load denotes, for example, a drive system or a control system of the electric vehicle 102, or an apparatus or a system driven by other electric energy. FIG. 5A illustrates an example of a processing procedure performed by the application 1011 in consuming the power. The application 1011 is loaded onto the memory 212, and is executed on the CPU 211, so the CPU 211 serves as the subject of performing the processing to be described below. The processing of FIG. 5A may be performed by the entity that consumes the power, for example, a controller of the electric vehicle 102, periodically or in response to the notification of power consumption transmitted to the charge and discharge management system 101 in accordance with an event.

In step S501, the CPU 211 receives the consumed amount of power, that is, the consumed power amount by the entity to be charged, for example, the electric vehicle 102.

In step S503, the CPU 211 generates a token transaction history corresponding to the consumed power amount received in S501, and registers the token transaction history in the second blockchain 1061. In S503, the transaction type of the transaction history is “deletion”, and the token quantity is a value corresponding to the consumed power amount. In addition, there is no movement of the power, and the ID of the movement object does not have to be recorded. The ID of the operation requester is the ID of the second blockchain 1061 given to the entity that has consumed the power, for example, the electric vehicle 102.

Note that the number of tokens is not limited to an integer, and may be expressed as a decimal. In this manner, it becomes possible to handle the power less than the unit of token (for example, 1).

In the above procedure, for the power consumption, a history of deletion of the green token in accordance with the consumed power amount is registered in the second blockchain 1061. In this manner, in the processing of FIGS. 4 and 5A, it becomes possible to register the transaction history of the token in the blockchain in accordance with the charge, the power transaction, and the power consumption.

Note that in the case where the renewable energy-derived power is used for charging an apparatus or the like outside the power management system 1, the procedure illustrated in FIG. 5A may be applied as the consumed power, and deletion of the token may be recorded as a transaction history in the first blockchain 1051.

### Token Transaction Processing

The token that has been issued in response to the transaction of renewable energy-derived power is an object of a transaction itself independently of the transaction of the power. For example, in a case where an economic value is applied to the token, or in a case where possession of the token is a certain requirement, for example, a requirement for receiving a subsidy or the like, the token can be an object of the transaction. In addition, the transaction of the token also enables exchange of the power that has been charged in the battery for the renewable energy-derived power without charging the renewable energy-derived power. FIG. 5B illustrates an example of a processing procedure performed by the application 1011 in the transaction of the token. The application 1011 is loaded onto the memory 212, and is executed on the CPU 211, so the CPU 211 serves as the subject of performing the processing to be described below. The processing of FIG. 5B is started in response to, for example, an operation on the mobile terminal 103 to execute the application 1011 to perform a transaction operation of the token. In this situation, the operator has an access right to the second blockchain 1061.

In step S511, the CPU 211 acquires a transaction content of the token. In this example, it is assumed that addition or deletion of the token is conducted in accordance with charge or consumption of the renewable energy-derived power corresponding to the token, and the transaction of the token is limited to the transfer, that is, the movement of the token.

In step S513, the CPU 211 registers a transaction history corresponding to the transaction content of the token in the second blockchain 1061. Here, the type of transaction is “movement”, and the token quantity is a value to be transacted. In addition, the ID of the movement object is the ID of the second blockchain 1061 given to an entity of a movement destination of the token. Further, the ID of the operation requester is the ID of the second blockchain 1061 given to an entity of a movement source of the token.

In the above procedure, it becomes possible to record the transaction of the token without the transaction of the power in the blockchain.

### Verification Processing of Power Transaction

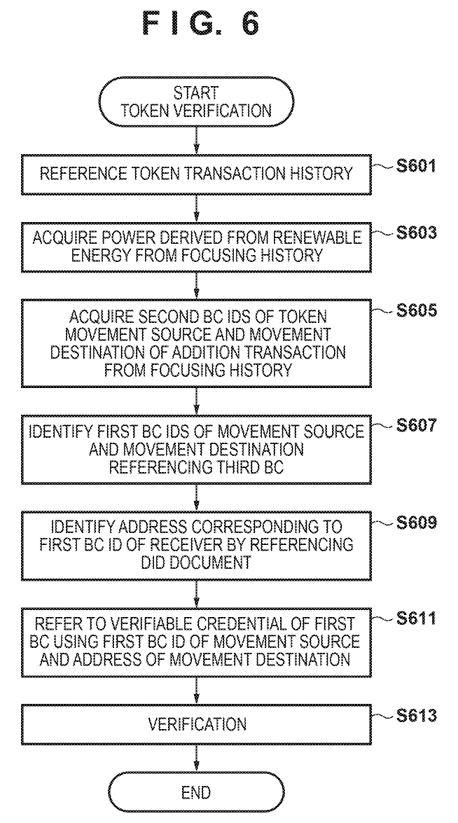

Regarding the transaction of the renewable energy-derived power and the transaction of the token, it is necessary to be able to verify whether the transaction is related to the authentic renewable energy-derived power. FIG. 6 illustrates an example of a procedure of verification processing. The application 1011 is loaded onto the memory 212, and is executed on the CPU 211, so the CPU 211 serves as the subject of performing the processing to be described below. For example, the application 1011 is executed on the mobile terminal 103, and when token verification is instructed in the application 1011, the processing of FIG. 6 is performed, accordingly. In this situation, the operator has an access right to the second blockchain 1061.

In step S601, the CPU 211 refers to the transaction history of the token in the second blockchain 1061. The transaction history of the token to be referred to is, for example, a transaction history in which the ID of the second blockchain given to the apparatus (referred to as a focusing apparatus) performing the processing of FIG. 6 is recorded as the ID of a person who has added the token, the ID of the movement destination of the token, and the ID of a consumer of the token. This transaction history will be referred to as a focusing transaction history.

In step S603, the CPU 211 identifies the number of tokens from the focusing transaction history, and acquires the corresponding power amount of the renewable energy-derived power from the number of identified tokens. For example, it is sufficient to obtain the number of tokens by adding the number of tokens for the addition and movement in the transaction type, or by subtracting the number of tokens for the deletion. Then, it is sufficient to convert it into a power amount per unit token.

In step S605, the CPU 211 identifies a transaction of “addition” in the transaction type by tracing back the transaction history from the focusing transaction history, and acquires the ID of the recorded movement object (a movement destination) and the ID of the operation requester (a movement source). In a case where there are a plurality of transactions of “addition” in the transaction type, S605 is performed for all the transactions.

In step S607, the CPU 211 refers to the third blockchain 1062, and identifies the ID (DID) of the first blockchain associated with each of the IDs of the movement destination and the movement source of the token that are the IDs of the second blockchain acquired in S605.

In step S609, the CPU 211 acquires the DID document, based on the ID of the movement destination identified in S607, and acquires the corresponding MAC address from the DID document.

In step S611, the CPU 211 acquires the DID document, based on the DID corresponding to the ID of the movement source of the token identified in S607, and acquires a public key included in the document. In addition, the CPU 211 refers to the verifiable credential from the first blockchain 1051, and the verifiable credential includes the DID corresponding to the ID of the movement source of the token as the DID of the entity of the charge source, and includes the MAC address identified in S609 as the MAC address of the entity of the charge destination.

In step S613, the CPU 211 verifies the electronic signature of the verifiable credential referred to in S611 with the public key that has been acquired. When all the verifications are successful, it can be determined that the token to be verified is proven to be derived from the renewable energy. In addition, by also verifying that the power amount acquired in S603 does not exceed the total power amount included in the verifiable credential that has been verified, it also becomes possible to verify consistency between the number of tokens and the amount of generated power.

Note that by providing a third party with the power amount acquired in S603 and the verifiable credential referred to in S611, it becomes possible for the third party to conduct the verification by using the DID included in the verifiable credential.

As described heretofore, according to the present embodiment, the information about the generation of the power that has been generated with the renewable energy is recorded in the first blockchain, and the transaction history of the token corresponding to the power generated with the renewable energy is recorded in the second blockchain. Then, one apparatus holds a correspondence table in which IDs, which are given in the respective blockchains, are associated with each other. Furthermore, the correspondence table is also recorded in the blockchain. With this configuration, falsification of information stored in each blockchain is prevented. In addition, by storing the information about the generation of the power in a blockchain different from a blockchain for the transaction history of the token, it also becomes possible for a third party who does not have the access right to the second blockchain to verify that the token corresponds to the renewable energy-derived power.

Furthermore, by managing the movement due to charging or the like of the renewable energy-derived power with a token, it becomes possible to facilitate the management of the transfer, reduce the processing load, and shorten a processing time.

### Modifications

Although the verifiable credential is stored in the first blockchain in the above embodiment, it may be stored in a database that is not a blockchain, for example, a distributed database. In this case, there is a possibility that the resistance to falsification of the verifiable credential is reduced. Thus, for example, a hash value of a charge result included in the verifiable credential may be obtained and recorded in the blockchain. Such a blockchain may be configured on, for example, the second blockchain platform 106 in the above embodiment. This makes it difficult to falsify the hash value of the charge result, and it becomes possible to verify the charge result by comparing the hash value with the hash value of the charge result included in the verifiable credential. In this manner, the operation performance for retrieval of the verifiable credential is improved, and resistance to the falsification can also be maintained.

Note that according to the present invention, a program of the procedure described in FIGS. 4 to 6 in the above embodiment is achieved by a circuit (hardware) such as an ASIC, for example. The present invention is also enabled by a combination of software and hardware.

The invention is not limited to the foregoing embodiments, and various variations/changes are possible within the spirit of the invention.

What is claimed is:

1. A power management system configured to manage a transaction of power derived from renewable energy, the power management system comprising:
a storage configured to hold first identification information, which is given to a battery, and which is identification information in a first blockchain, and second identification information, which is identification information in a second blockchain,
at least one memory storing instructions; and
at least one processor that is in communication with the at least one memory and that, when executing the instructions, cooperates with the at least one memory to execute processing, the processing including:
storing, in the first blockchain, a transaction result of the power derived from the renewable energy, which is obtained from a charging station and charged in the battery, in association with the first identification information;
storing, in the second blockchain, a transaction history of a token in accordance with the transaction result in association with the second identification information; and
storing association information in which the first blockchain and the second blockchain are associated with each other.

2. The power management system according to claim 1, further comprising
a database configured to store a public key in association with every piece of the first identification information, wherein
a hash value generated from a secret key for every piece of the first identification information and the transaction result is stored together with the transaction result in the first blockchain.

3. The power management system according to claim 1, wherein
the transaction result stored in the first blockchain relates to the power derived from the renewable energy that is newly generated and charged in the battery, and
the transaction history of the token stored in the second blockchain includes: generation and transfer of the token in accordance with the transaction of the power derived from the renewable energy; and deletion of the token in accordance with consumption of the power derived from the renewable energy.

4. The power management system according to claim 1, wherein
in the association information, the first identification information in the first blockchain given to the battery is associated with the second identification information in the second blockchain.

5. The power management system according to claim 1, wherein
in storing the association information, the association information is stored in a third blockchain.

6. The power management system according to claim 1, wherein
the first blockchain is a blockchain of a distributed identifier, and
the second blockchain is Ethereum (registered trademark).

7. The power management system according to claim 1, wherein the charging station includes a watt meter that measures the amount of power that has been generated by the renewable energy and charged from the charging station to another apparatus.

8. An information processing apparatus configured to manage a transaction of power derived from renewable energy, the information processing apparatus comprising:
a storage configured to hold first identification information, which is given to a battery, and which is identification information in a first blockchain, and second identification information, which is given to a battery, and which is identification information in a second blockchain,
at least one memory storing instructions; and
at least one processor that is in communication with the at least one memory and that, when executing the instructions, cooperates with the at least one memory to execute processing, the processing including:
acquiring a transaction result of the power derived from the renewable energy;
storing, in the first blockchain, the transaction result in association with the first identification information; and
storing, in the second blockchain, a transaction history of a token in accordance with the transaction result of the power in association with the second identification information, wherein
the first blockchain and the second blockchain are associated with each other by association information, in which the first identification information and the second identification information are associated with each other, and which is held in a holding unit.

9. A power management method, by a power management system, for managing a transaction of power derived from renewable energy, the method comprising:
holding first identification information, which is given to a battery, and which is identification information in a first blockchain, and second identification information, which is identification information in a second blockchain;
storing association information in which the first blockchain and the second blockchain are associated with each other;
storing, in the first blockchain, a transaction result of the power derived from the renewable energy charged in the battery in association with the first identification information; and
storing, in the second blockchain, a transaction history of a token in accordance with the transaction result in association with the second identification information.
